(19) United States
(12) Patent Application Publication
(10) Pub. No.: US 2007/0288979 A1
(43) Pub. Date: Dec. 13, 2007

(54) Advertisement charging apparatus and method thereof

(76) Inventor: David Yen, Burnaby (CA)

Correspondence Address: RABIN & Berdo, PC, 1101 14TH STREET, NW, SUITE 500, WASHINGTON, DC, 20005, US

(21) Appl. No.: 11/808,658

(22) Filed: Jun. 12, 2007

(30) Foreign Application Priority Data
Jun. 12, 2006 (CN) 200610091327.X

(51) Int. Cl. H04N 7/173; H04N 7/025; H04N 7/10

(52) U.S. Cl. 725/114; 725/32; 725/36

(57) ABSTRACT

The charging apparatus of the present invention includes a condition setting module, a bid module, a comparing module and a sort module. The present invention provides an advertiser to set conditions to broadcast his advertisement. When two advertisers set same conditions, the present invention also provides a bit interface for advertisers to bid for the broadcasting conditions.

### RELATED APPLICATIONS

This application claims priority to China Application Serial Number 200610091327.X, filed Jun. 12, 2006, which is herein incorporated by reference.

### FIELD OF THE INVENTION

The present invention is about a charging apparatus and method thereof, and more particularly, about an advertisement charging apparatus and method thereof.

### BACKGROUND OF THE INVENTION

Using advertisement board to advertise a new product or service of a company to a customer is a popular marketing method.

A typical advertisement board can only show a fixed picture of a product. Because only a fixed product picture can be shown, the charge is also fixed.

Today, advertisement boards that can display video of products have replaced the fixed picture advertisement boards. A video for a product is recorded first. Then, this video is displayed on the advertisement board according to the environmental conditions. This advertising method can provide more vivid product information to customers. Different videos can be displayed at different times based on the environmental conditions. Therefore, the advertisement efficiency is better than that of the fixed picture advertisement board.

However, the advertisement is displayed based on the environmental condition. It is not fair to use a fixed charge rate for displaying each advertisement. Therefore, an advertisement charging method based on environmental conditions is required.

### SUMMARY OF THE INVENTION

Therefore, the main purpose of the present invention is to provide an advertisement charging apparatus that can charge different display rates according to different environmental conditions.

The other purpose of the present invention is to provide an advertisement charging method that can charge different display rates according to environmental conditions.

Accordingly, the present invention provides a charging apparatus. The charging apparatus includes a condition setting module, a bid module, a comparing module and a sort module. The condition setting module provides an advertiser with the ability to set the conditions to broadcast his advertisement. The bid module provides advertisers with the ability to bid for the broadcast conditions. The comparing module compares the prices bid by the advertisers. The sort module may arrange the display order for the advertisements based on the compared result.

In another embodiment, the present invention provides a charging method. First, the advertisers set the broadcast conditions. Then, a determination step is performed to determine whether the same broadcast conditions are repeated set or not. When no same broadcast conditions are repeated set, the advertisements are broadcast based on setting the broadcast conditions. When the same broadcast conditions are repeatedly set, the advertisers may bid for the broadcast conditions. Next, the prices bid by the advertisers are compared to determine the display order of the advertisements. Finally, the advertisements are displayed based on their display order.

The charging apparatus and method thereof have the following advantages. First, the bit method may create the best profit for the owner of the advertisement board. Second, the bid method may help the advertisers to reduce the chance of the competitors to introduce their products. Therefore, this apparatus and method of the present invention may create a win-win situation for the advertisement board owner and the advertisers.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of an interactive advertisement board according to the present invention.

FIG. 2 illustrates a schematic diagram of a charging apparatus according to the present invention.

FIG. 3 illustrates a flow chart for operating the charging apparatus of the present invention.

### DETAILED DESCRIPTION OF THE PREFERRED EMBODIMENT

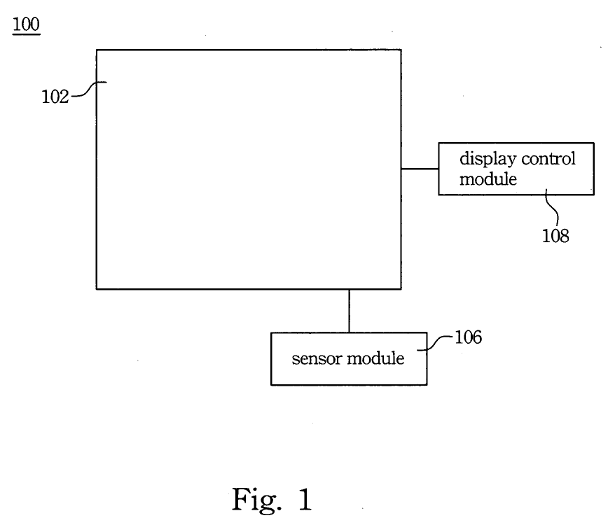

FIG. 1 illustrates a schematic diagram of an interactive advertisement board according to the present invention. The interactive advertisement board 100 includes a display module 102, a sensor module 106 and a display control module 108.

The sensor module 106 and the display control module 108 are coupled to the display 102. This sensor module 106 is used to detect and monitor environmental conditions and to send the results to the display control module 108. The display control module 108 is used to manage the timing, frequency and type of special advertisement that is shown on the display in accordance with the environmental conditions.

There are many different advertisements stored in the display control module 108. A corresponding relationship between each advertisement and the sensor module 106 is set first. When a special environmental event occurs, the display control module 108 controls a corresponding advertisement to display in the display module 102. The sensor module 106 is a temperature sensor, a humidity sensor, a color sensor, a sound sensor, a speed sensor, or other sensor or combination of sensors. The display module is a TV, an LCD, an LED display, or another display. It is noticed that the display control module 108 and the display module 102 are connected together either physically or offsite through some communication means. Therefore, the display control module 108 may remotely control the display module.

In one embodiment, if the advertisement content is of an ice cream product, a drink product or summer clothes, the desirability of these products are proportional to the temperature. In other words, higher temperatures will increase the desire to buy, and advertise these products in a higher temperature may promote the advertisement efficiency. When advertising, a critical temperature may be set in the display control module 108. When the sensor module 106 detects that the environmental temperature is larger than the critical temperature, the interactive advertisement board 100 is forced to broadcast the foregoing advertisements by the display control module 108.

Moreover, when many advertisements are set to the same environmental conditions to display, a charging apparatus in the present invention is used to arrange the display order for these advertisements.

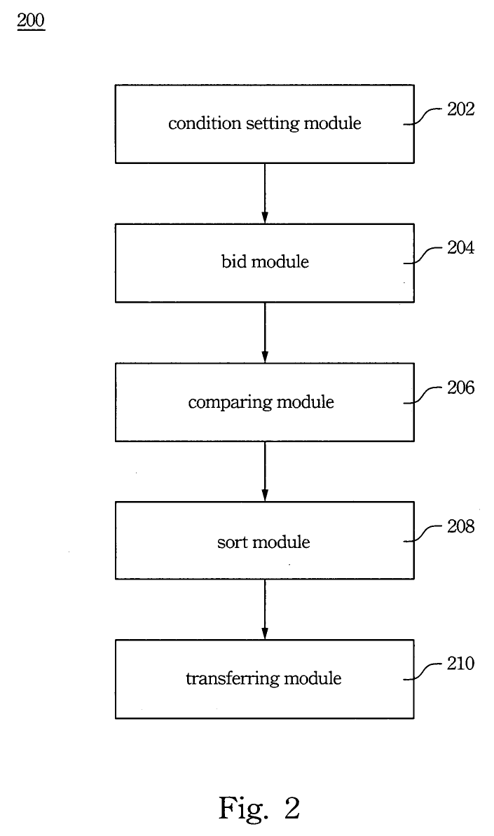

FIG. 2 illustrates a schematic diagram of the charging apparatus of the present invention. The charging apparatus 200 includes a condition setting module 202, a bid module 204, a comparing module 206 and a sort module 208. The condition setting module 202 provides an advertiser with a set of conditions to broadcast the advertisement. When two advertisers set the same conditions for broadcasting their advertisements, the setting module 202 may send the broadcast conditions to the bid module 204 to inform the two advertisers the same broadcast conditions have been selected. At this time, the two advertisers may respectively set acceptable highest advertising price for broadcasting their advertisement through the bid module. Then, the two acceptable highest prices respectively set by the two advertisers are sent to the comparing module 206 for comparison. Then, a comparing result is sent out from the comparing module 206 to the sort module 208. The sort module 208 may arrange the display order for the advertisements based on the comparing result. Finally, the advertisement with the highest priority is sent from the transferring module 210 via a wired or wireless transfer to the display control module 108 to be broadcast. Then, the charge is the bid for advertising this advertisement.

It is noticed that when bidding, the advertisers also may set the times or period for broadcasting their advertisements. In this case, after the set times or period for broadcasting advertisements is satisfied, the bid process is performed again to renew the display order. Moreover, the advertisers who decline to bid or fail to get the higher priority for the broadcasting advertisement may renew the broadcasting advertisement conditions through the condition setting module 202 to avoid conflict. On the other hand, the charging apparatus 200 may also provide the owner of the advertisement board to set the broadcast conditions. In this case, the owner may set the different prices for different broadcast conditions. Then, the advertisers may select the suitable broadcast conditions based on their budget. On the other hand, the owner of the advertisement board may only set the broadcast conditions but not set the corresponding prices. In this case, the price is determined by the advertisers. Moreover, the bid may be performed through the Internet. Therefore, a real time bid may can occur. For example, when a special event happens, such as a special festival, and a special product is required in such an event, the advertisers may bid in real time through the charging apparatus 200 to shoot for the broadcast opportunity.

For example, an advertiser of soft drink A may through the condition setting module 202 set the temperature broadcast conditions to be higher than 30° C., humidity higher than 70%, the average speed of the vehicles lower than 20 km/hr and the time for broadcasting this advertisement from 17:00 to 22:00. On the other hand, an advertiser of soft drink B through the condition setting module 202 may also set the same broadcast conditions. At this time, the setting module 202 may send the foregoing broadcast conditions to the bid module 204. The bid module 204 may inform the two advertisers to bid. The two advertisers may set acceptable highest price through the bid module 204. Then, the two prices are sent to the comparing module 206 to compare. A compared result is sent out from the comparing module 206 to the sort module 208. The sort module 208 may arrange the display order for the advertisements based on the comparing result. Finally, the advertisement with the highest priority is sent to the transferring module 210 to transfer to the display control module 108.

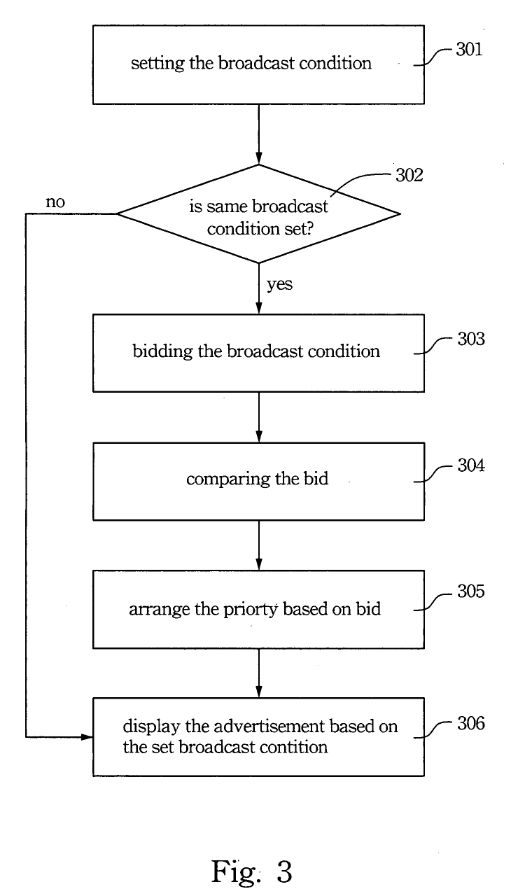

FIG. 3 illustrates a flow chart for operating the charging apparatus of the present invention. Please refer to FIG. 2 and FIG. 3 together. In step 301, the advertisers set the broadcast conditions through the condition setting module 202. Then, the step 302 is performed to determine whether or not the same broadcast conditions are a repeated set. When no same broadcast conditions are repeated, step 306 shows the broadcasting of advertisements based on the setting broadcast conditions. When the same broadcast conditions are a repeated set, the step 303 is performed. In this step, the advertisers may bid the broadcast conditions through the bid module 204. Next, in the step 304, these prices bid by the advertisers are compared by the comparing module 206. Then, in the step 305, the comparing result is sent out from the comparing module 206 to the sort module 208. The sort module 208 may arrange the display order for the advertisements based on the compared result. Finally, in the step 306, the advertisement with the highest priority is sent to the transferring module 210 to transfer to the display control module 108 to be displayed.

Accordingly, the charging apparatus of the present invention includes a condition setting module, a bid module, a comparing module and a sort module. The present invention provides an advertiser with a set of conditions to broadcast his advertisement. When two or more advertisers set the same conditions, the bid module provides the advertisers with the opportunity to bid for the broadcasting conditions. These prices are compared by the comparing module. The sort module may arrange the display order for the advertisements based on the comparing result. Finally, these advertisements may be displayed based on the display order.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. An advertisement charging apparatus, comprising:
a condition setting module providing advertisers with the ability to set broadcast conditions to broadcast their advertisement;
a bid module, when the same broadcast condition is set by at least two advertisers, the said two advertisers may bid the broadcast condition through the said bid module;
a comparing module for comparing the prices bid by the advertisers and generating a compared result; and
a sort module to arrange the display order based on the comparing result, wherein the advertisement of the advertiser winning the bid is a top priority and the advertiser is charged based on his bid.

2. The apparatus according to claim 1, wherein said broadcast conditions are the environmental temperature, the environmental humidity, the environmental color, the environmental sound, the environmental speed or a combination thereof.

3. The apparatus according to claim 1, further comprising a transferring module for transferring the advertisement of the advertiser winning the bid.

4. The apparatus according to claim 3, wherein a wireless transfer is used to transfer the advertisement.

5. The apparatus according to claim 3, wherein a wired transfer is used to transfer the advertisement.

6. An advertisement charging method, comprising:
setting broadcast conditions to broadcast advertisements by advertisers;
bidding the broadcast condition by at least two advertisers when the same broadcast conditions are set by said two advertisers;
comparing the prices bid by the advertisers and generating a comparing result; and
arranging the display order based on the comparing result, wherein the advertisement of the advertiser winning the bid is a top priority and the advertiser is charged based on his bid.

7. The method according to claim 6, wherein said broadcast conditions are the environmental temperature, the environmental humidity, the environmental color, the environmental sound, the environmental speed or a combination thereof.
